(19) United States
(12) Patent Application Publication
(10) Pub. No.: US 2013/0320190 A1
(43) Pub. Date: Dec. 5, 2013

(54) LIGHT SOURCE DEVICE

(71) Applicant: Industrial Technology Research Institute, Hsinchu (TW)

(72) Inventors: Chang-Sheng Chu, Hsinchu City (TW); Yu-Tang Li, New Taipei City (TW); Shuang-Chao Chung, Hsinchu County (TW); Chih-Hsun Fan, Hsinchu City (TW); Ming-Chia Li, Taichung City (TW); Kuo-Tung Tiao, Hsinchu County (TW)

(21) Appl. No.: 13/905,138

(22) Filed: May 30, 2013

Related U.S. Application Data
(60) Provisional application No. 61/653,400, filed on May 30, 2012.

(30) Foreign Application Priority Data
Dec. 28, 2012 (TW) 101151051

(51) Int. Cl. G02B 26/08; G02B 26/10; G02B 26/02; G01J 1/04

(52) U.S. Cl. CPC G02B 26/0808; G01J 1/044; G01J 1/0407; G02B 26/105; G02B 26/02
USPC 250/205; 250/226; 362/230; 362/231

(57) ABSTRACT

A light source device including at least one light source, an optical module, a diffractive optical element, and a shielding component is provided. The at least one light source emits at least one light beam, and the light beam has a wavelength range. The optical module is disposed on a transmission path of the light beam to provide a plurality of optical surfaces. The optical surfaces respectively have a plurality of different inclination angles, so as to transmit at least a portion of the light beam having at least a predefined wavelength to a plurality of different directions. The diffractive optical element is disposed on the transmission path of the light beam, so as to diffract the light beam. The shielding component has an outlet. A portion of the diffracted light beam passes through the outlet to the outside.

### CROSS-REFERENCE TO RELATED APPLICATION

This application claims the priority benefits of U.S. provisional application Ser. No. 61/653,400, filed on May 30, 2012 and Taiwan application serial no. 101151051, filed on Dec. 28, 2012. The entirety of each of the above-mentioned patent applications is hereby incorporated by reference herein and made a part of this specification.

### TECHNICAL FIELD

The technical field relates to a light source device.

### BACKGROUND

From research and applications with plants, light has nowadays gradually moved into areas of human disease prevention and treatment. For instance, light can be applied in photodynamic therapy (photoradiation therapy) to promote necrosis of tumor cells, cell culture in cell factories, and also for skin care and spectral radiation in medical cosmetics. Moreover, when treating patients of depression, light of different spectrums, bandwidth, and illuminance can be used for treatment.

Due to the varying needs of plants and humans, the spectrum, bandwidth, and illuminance required by plants and humans are different. For a plant factory, the wavelength range of 315-400 nm can be used to suppress the stem elongation of plants. The absorption ratios of chlorophyll and carotenoid are the greatest at the wavelength range of 400-520, which contributes to maximum photosynthesis effect. The chlorophyll absorption rate is low at the wavelength range of 610-720, which significantly impacts photosynthesis and photoperiodism. Moreover, plants require different illumination at different stages of the growth period.

Therefore, one research area is in effectively designing light sources having different spectrums or light source devices with adjustable spectral bandwidths.

### SUMMARY

An embodiment of the disclosure provides a light source device, including at least one light source, an optical module, a diffractive optical element, and a shielding component. The at least one light source emits at least one light beam, and the at least one light beam has a wavelength range. The optical module is disposed on a transmission path of the light beam to provide a plurality of optical surfaces. The optical surfaces respectively have a plurality of different inclination angles, so as to transmit at least a portion of the light beam having at least a predefined wavelength to a plurality of different directions. The diffractive optical element is disposed on the transmission path of the light beam, so as to diffract the light beam. Moreover, the shielding component has an outlet, and a portion of the diffracted light beam passes through the outlet to the outside.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 is a schematic view of a light source device according to an embodiment of the disclosure.

FIG. 2 is a partially enlarged schematic view of the diffractive optical element and the shielding component in FIG. 1.

FIG. 3 shows another variation of the diffractive optical element in FIG. 2.

FIG. 4 is a schematic view of a light source device according to another embodiment of the disclosure.

FIG. 5 is a schematic view of a light source device according to an embodiment of the disclosure.

FIG. 6 is a schematic view of a light source device according to another embodiment of the disclosure.

FIG. 7 is a schematic view of a light source device according to another embodiment of the disclosure.

FIG. 8 is a schematic view of a light source device according to an embodiment of the disclosure.

### DESCRIPTION OF EMBODIMENTS

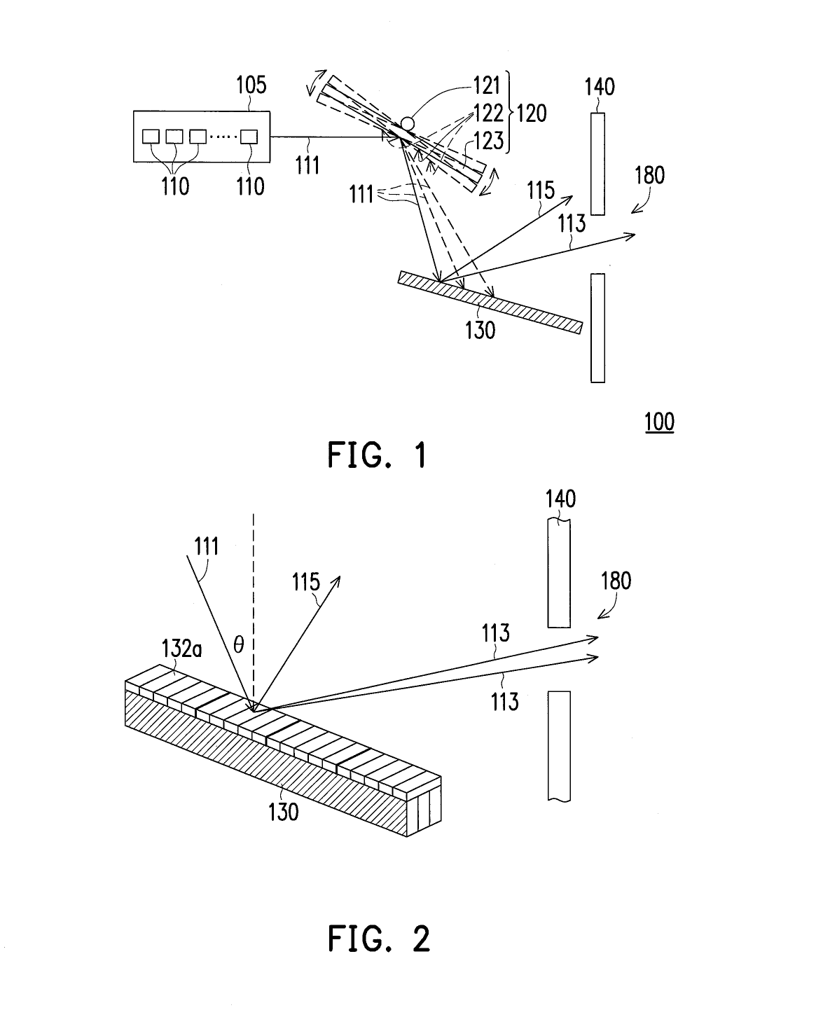

FIG. 1 is a schematic view of a light source device according to an embodiment of the disclosure. With reference to FIG. 1, a light source device 100 of the present embodiment includes at least one light source 110 (a plurality of light sources 110 are exemplarily shown in FIG. 1), an optical module 120, a diffractive optical element (DOE) 130, and a shielding component 140. The at least one light source 110 emits at least one light beam 111, and the at least one light beam 111 has a wavelength range. For example, in the present embodiment, a plurality of light sources 110 respectively emit a plurality of light beams 111. Each of the light beams 111 has a wavelength range, and the light sources 110 may form a light source module 105. The optical module 120 is disposed on a transmission path of the light beam 111 to provide a plurality of optical surfaces 122. The optical surfaces 122 respectively have a plurality of different inclination angles, so as to transmit at least a portion of the light beam 111 having at least a predefined wavelength to a plurality of different directions. The diffractive optical element 130 is disposed on the transmission path of the light beam 111, so as to diffract the light beam 111. Moreover, the shielding component 140 has an outlet 180, and a portion of the diffracted light beam 111 passes through the outlet 180 to the outside, so that the light source device 100 of the present embodiment can modulate light of different wavelength spectrums, bandwidths, and illuminance.

The light source 110 of the present embodiment may be a combination of monochromatic light sources such as light emitting diodes (LEDs) or laser diodes (LDs). In the present embodiment, the light source 110 may be formed by a plurality of LEDs of different emitting wavelengths. The peak wavelengths in the spectrum of the light emitted from the LEDs may be λ1, λ2, . . . , λn, and the light source 110 may control light of these wavelengths independently. Nevertheless, the light source 110 of the present embodiment is not limited thereto.

In the present embodiment, the optical module 120 may be a scanning mirror 123, for example. The scanning mirror 123 has a reflection surface and a rotating axis 121. Moreover, the scanning mirror 123 is adapted to swing around the rotating axis 121 to change the inclination angle of the reflection surface, and the aforementioned optical surfaces 122 are respectively formed by the reflection surface of the scanning mirror 123 at a plurality of different time points. In the present embodiment, the optical module 120 can transmit the light beam 111 from the light source 110 to the diffractive optical element 130. For example, the scanning mirror 123 may reflect the light beam 111 from the light source 110 to the diffractive optical element 130, and then the diffractive optical element 130 may then diffract the portion of the light beam 111 from the optical module 120 to the outlet 180. In other words, the light beam 111 from the light source 110 is first transmitted to the optical module 120, and then transmitted to the diffractive optical element 130, although the disclosure is not limited thereto. In other embodiments, the light beam 111 from the light source 110 can be first transmitted to the diffractive optical element 130, and then transmitted to the optical module 120.

The optical surfaces 122 with different inclination angles of the scanning mirror 123 can respectively reflect light beams 111 of different peak wavelengths λ1, λ2, . . . , λn emitted by the light source 110. For example, when the scanning mirror 123 swings back and forth, the light source 110 can sequentially emit light beams 111 of peak wavelengths λ1, λ2, . . . , λn, . . . , λ2, λ1. However, in other embodiments, the light source 110 may also emit a light beam 111 of one peak wavelength, such that when the scanning mirror 123 swings back and forth, the light beam 111 can be reflected to the diffractive optical element 130 to produce different diffraction effects.

FIG. 2 is a partially enlarged schematic view of the diffractive optical element and the shielding component in FIG. 1. With reference to FIG. 2, the diffractive optical element 130 of the present embodiment may be a transmissive diffractive optical element or a reflective diffractive optical element, such as a diffraction grating, a computer generated holograph (CGH), or a holographic optic element (HOE). In the present embodiment, the diffractive optical element 130 has a phase structure set 132a. The phase structure set 132a includes a plurality of phase structures, and the phase structures are at least partially different. The optical surfaces 122 cause the light beams 111 to be respectively incident on different phase structures at a plurality of different incident angles θ. Moreover, the phase structure set 132a generates a plurality of diffraction lights 113 and 115 of different orders corresponding to the light beams 111 and the incident angles θ, and diffracts the diffraction lights 113 and 115 toward different directions. At least a portion of the phase structures diffract a portion of the diffraction lights 113 of at least a portion of the light beams 111 having at least a predefined wavelength to the outlet 180.

In specifics, in the light source device 100 of the present embodiment, the light beams 111 emitted by the light source 110 may have different peak wavelengths, such as λ1, λ2, . . . , λn. For example, the light beams 111 with the peak wavelength of λ1 can be directly or indirectly transmitted to the diffractive optical element 130, and irradiated on the phase structure set 132a to generate diffraction. The light beams 111 with the peak wavelength of λ1 have a wavelength range. That is, the light beams 111 with the peak wavelength of λ1 have a plurality of different wavelengths within this wavelength range. When light beams 111 are incident on the phase structure set 132a of the diffractive optical element 130 at the incident angle θ, the components of the light beams 111 having different wavelengths are emitted from the phase structure set 132a at different angles. Moreover, light beam 111 forms different orders of diffraction lights 113 and 115 after being diffracted. In the present embodiment, a portion of the diffraction lights with orders of high intensity may be selected (e.g., 1^{st} order diffraction light or −1^{st} order diffraction light, and −1^{st} order diffraction light 113 is used in FIG. 1 exemplarily) to transmit to the outlet 180. In specifics, in the −1^{st} order diffraction light 113, various components of different wavelengths are transmitted toward the outlet 180 in different directions. The desirable wavelength components for transmission in the −1^{st} order diffraction light 113 can be transmitted outside through the outlet 180 by the placement of the optical surfaces 122 and the diffractive optical element 130 as well as properly designing the angles thereof. Moreover, the shielding component 140 can block the undesirable wavelength components in the −1^{st} order diffraction light 113. Furthermore, in the present embodiment, the 0^{th} order diffraction light 115 is blocked by the shielding component 140 and cannot be transmitted out from the outlet 180. Accordingly, by using the shielding component 140 to block the light beams 111 having wavelengths which do not need to be outputted, the light source device 100 can convert the wide bandwidth light beams 111 emitted by the light source 110 (e.g. LED) into narrow bandwidth light beams 111. Although the prior description uses the −1^{st} order diffraction light 113 as an illustrative example, in other embodiments, diffraction lights of the 1^{st} order, 2^{nd} order, −2^{nd} order, or other non-zero orders can be transmitted toward the outlet 180.

When the wavelength ranges of the light beams 111 emitted by the light source partially overlap by a large degree, even though the shielding component 140 made the bandwidths of these light beams 111 narrow, a continuous spectrum can be formed since the wavelength ranges of the light beams 111 outputted from the outlet 180 can be joined. A solar spectrum can even be formed when sufficient quantity and types of the light source 110 are available. When the wavelength ranges of the light beams emitted by the light source 110 are dispersed from each other, the shielding component 140 causes these wavelength ranges to be narrow and dispersed wavelength ranges. When there is only one light source 110, the shielding component 140 can cause the light beam 111 outputted from the outlet 180 to be a monochromatic and narrow bandwidth light beam. In specific, the light outputted by the light source device 100 of the present embodiment can form a continuous spectrum or a spectrum having a single narrow band or multiple narrow bands. Moreover, light between the wavelength range of, for example, 400-700 nm and having different illuminance can be emitted in accordance with different needs corresponding to the human body and the therapy. Therefore, preferable applications in the prevention and treatment of human diseases can be achieved.

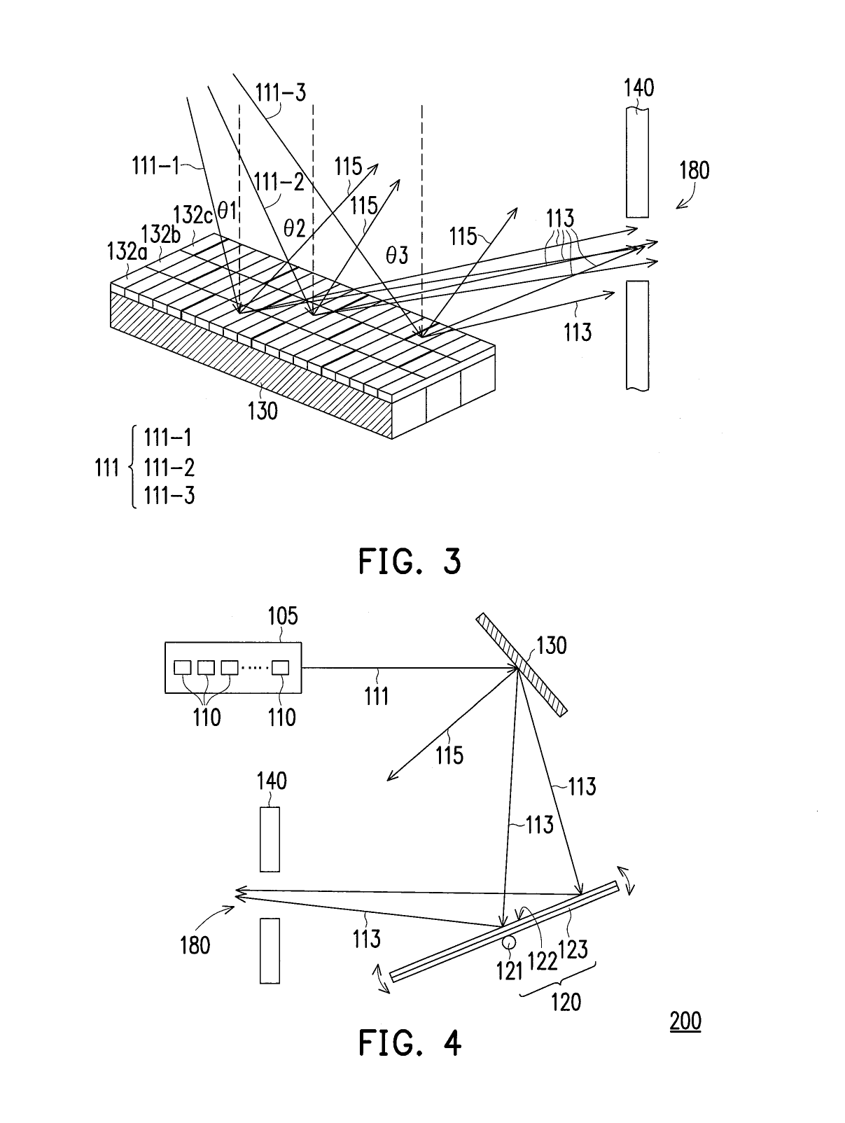

FIG. 3 shows another variation of the diffractive optical element in FIG. 2. With reference to FIG. 3, in another embodiment, the diffractive optical element 130 has a plurality of phase structure sets 132a, 132b, and 132c. Moreover, the at least one light beam 111 emitted by the light source 110 are a plurality of light beams 111-1, 111-2, and 111-3 having different wavelength ranges. The light beams 111-1, 111-2, and 111-3 are respectively incident on the phase structure sets 132a, 132b, and 132c of the diffractive optical element 130, and form a plurality of incident angles θ1, θ2, and θ3. The phase structures 132a, 132b, and 132c respectively generate a plurality of diffraction lights 113 and 115 of different orders corresponding to the incident angles θ1, θ2, and θ3. The phase structures 132a, 132b, and 132c respectively diffract a portion of the diffraction lights 113 of the portion of the light beams 111-1, 111-2, and 111-3 having predefined wavelengths to the outlet 180. In specifics, in the present embodiment, the light beam 111-1 may be a blue light having a wavelength range of 450-475 nm, for example, the light beam 111-2 may be a green light having a wavelength range of 495-570 nm, the light beam 111-3 may be a red light having a wavelength range of 620-750 nm. The green, blue, and red lights may be respectively incident on the corresponding phase structure sets 132a, 132b, and 132c with different incident angles θ1, θ2, and θ3. The phase structure sets 132a, 132b, and 132c can respectively generate diffraction lights 113 and 115 of different orders for various different wavelength components in the light beams 111-1, 111-2, and 111-3, and transmit the diffraction lights 113 and 115 to different directions outwards. In the −1^{st} order diffraction light 113, a portion of the diffraction light 113 having the predefined wavelengths (e.g. 460 nm, 500 nm, and 650 nm, respectively) can pass through the outlet 180, and the portion of the diffraction light 113 having other wavelengths and the 0^{th} order diffraction light 115 are blocked by the shielding component 140. Nevertheless, the present embodiment is not limited thereto.

FIG. 4 is a schematic view of a light source device according to another embodiment of the disclosure. With reference to FIGS. 1 and 4, a light source device 200 of the present embodiment is similar to the light source device 100 of the previous embodiment, and similar elements are represented by similar reference labels. However, a difference therebetween lies in that, in the present embodiment, the light beam 111 from the light source 110 is first transmitted to the diffractive optical element 130 to be diffracted, and then transmitted to the outlet 180 by the optical module 120. In other words, the diffractive optical element 130 first diffracts the light beam 111 from the light source 110 to the optical module 120, and then the optical module 120 transmits a portion of the light beam 111 from the diffractive optical element 130 to the outlet 180. That is, in the light source device 200 of the present embodiment, a transmission order of the light beam 111 from the light source 110 to the optical elements is different from the previous embodiments.

The disclosure does not limit the transmission order of the light beam 111 from the light source 110 to the optical elements. According to usage needs and design, the light beam 111 from the light source 110 can be first transmitted to the one of the optical module 120 and the diffractive optical element 130, and then transmitted to the other. The light source devices 100 and 200 designed according to FIGS. 1 and 4 can both modulate light having different wavelength spectrums, bandwidths, and illuminance.

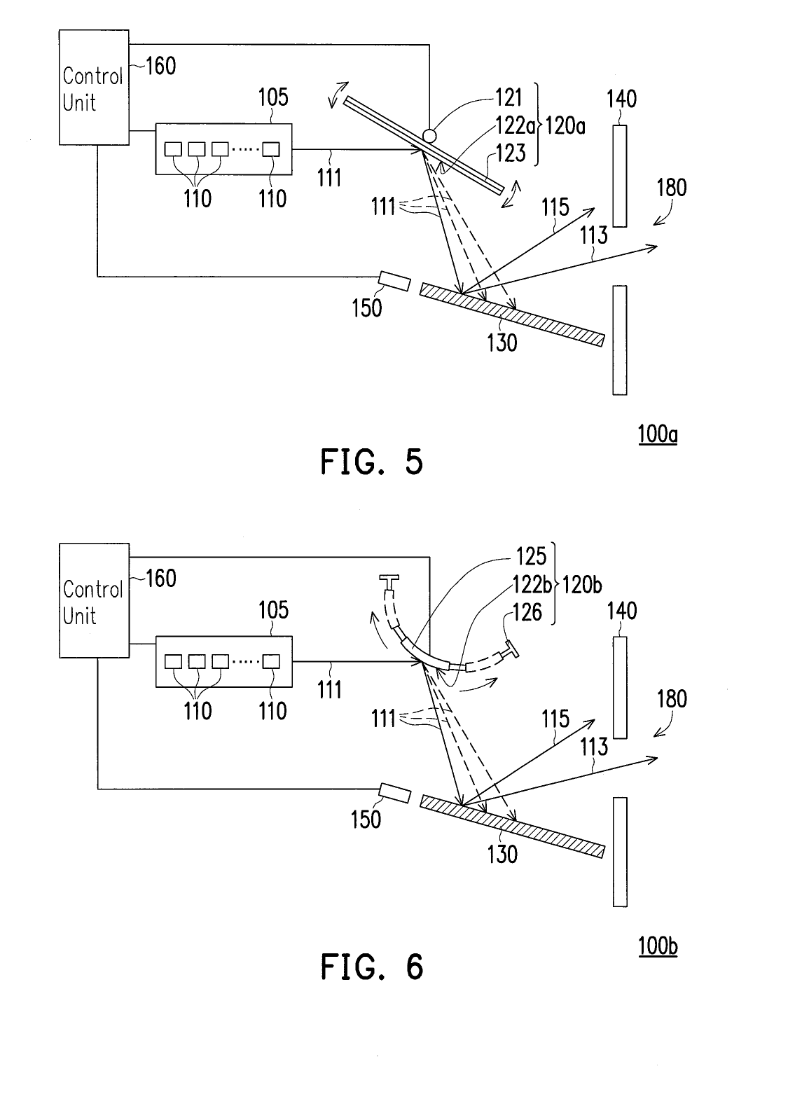

FIG. 5 is a schematic view of a light source device according to another embodiment of the disclosure. With reference to FIGS. 1 and 5, a light source device 100a of the present embodiment is similar to the light source device 100 of the previous embodiment, and similar elements are represented by similar reference labels with further elaboration thereof omitted hereafter. However, a difference therebetween lies in that, the light source device 100a of the present embodiment further includes a light detector 150 and a control unit 160. The light detector 150 may have a filter disposed on a side of the diffractive optical element 130. The light beams 111 emitted by the light source 110 are transmitted to the light detector 150 within a part of a time period. That is, in the present embodiment, the scanning mirror 123 reflects the light beams 111 emitted by the light source 110 to the light detector 150 within a part of a time period of the scanning mirror 123 swinging back and forth. Moreover, the light source 110, an optical module 120a, and the light detector 150 are electrically connected with the control unit 160. The control unit 160 can determine a period of a transmission direction of the light beams 111 being changed according to a time for the light detector 150 to detect the light beams 111, or according to a time for the light detector 150 to detect a portion of the light beams 111 corresponding to a certain wavelength range. In specifics, the control unit 160 can adjust an operating parameter of at least one of the light source 110 and the optical module 120a according to the determined period of the transmission direction of the light beam 111 being changed.

In the present embodiment, the light source 110 may a pulse light source, for example, and the operating parameter of the light source 110 includes at least one of a time point and a period of the light source generating a pulse. The optical module 120a respectively forms a plurality of optical surfaces 122a at a plurality of different time points, and the operating parameter of the optical module 120a includes at least one of a time point and a period of forming these optical surfaces 122a.

In the present embodiment, the filter filters the light emitted toward the light detector 150, so as to determine the wavelength of the light. The light detector 150 is responsive to light of a portion of the wavelength range within the light beams 111, and is irresponsive to light of another portion of the wavelength range within the light beams 111. However, in other embodiments, the light detector 150 may also be responsive to light of all wavelengths within the light beam 111. In specifics, according to the operating parameters of the light source 110 and the optical module 120a, and the wavelengths of the light beams 111 outputted from the outlet 180, the control unit 160 can enable the light source device 100a of the present embodiment to modulate light of different wavelength spectrums, bandwidths, and illuminance.

FIG. 6 is a schematic view of a light source device according to another embodiment of the disclosure. With reference to FIGS. 5 and 6, a light source device 100b of the present embodiment is similar to the light source device 100a of the previous embodiment, and similar elements are represented by similar reference labels with further elaboration thereof omitted hereafter. However, a difference therebetween lies in that, an optical module 120b of the present embodiment includes a curved rail 126 and a reflector 125. The reflector 125 slides on the curved rail 126 and has a reflection surface. When the reflector 125 moves to a plurality of different positions on the curved rail 126, an inclination angle of the reflection surface is different. The optical surfaces 122b are respectively formed by the reflection surface when the reflector 125 respectively slides to these different positions.

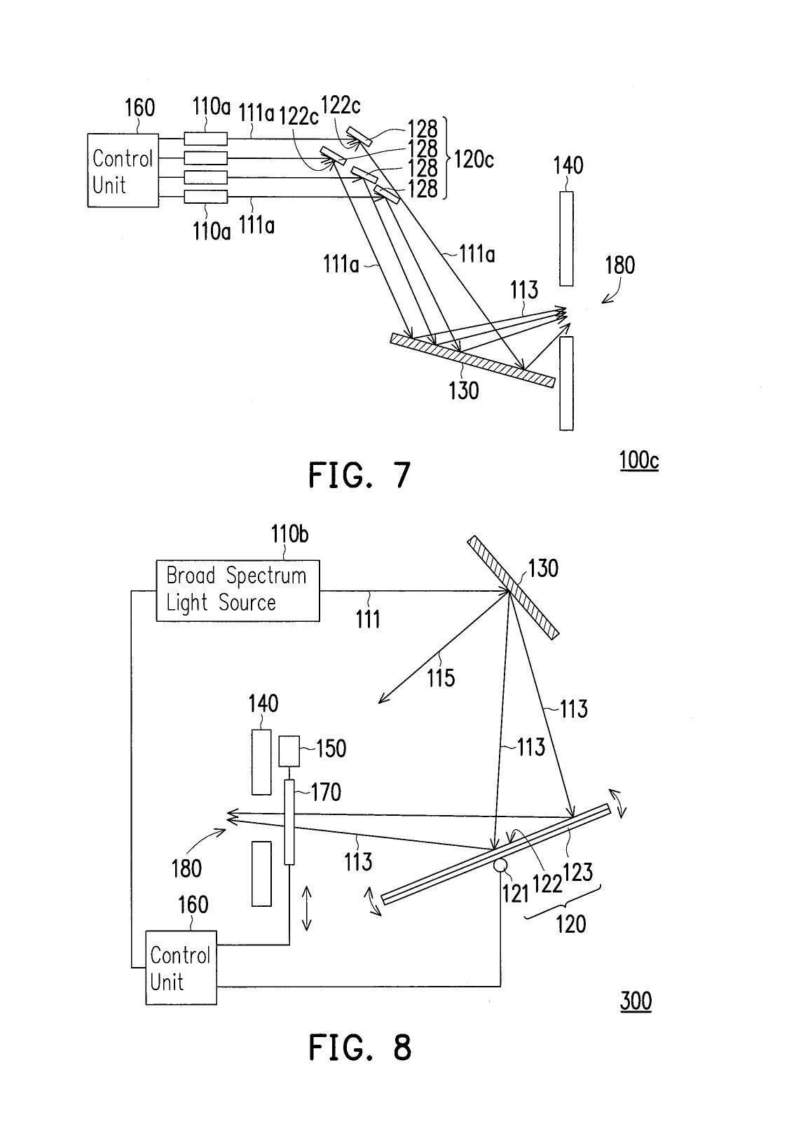

FIG. 7 is a schematic view of a light source device according to another embodiment of the disclosure. With reference to FIGS. 5 and 7, a light source device 100c of the present embodiment is similar to the light source device 100a of the previous embodiment, and similar elements are represented by similar reference labels with further elaboration thereof omitted hereafter. However, a difference therebetween lies in that, in the present embodiment, there are a plurality of light sources 110a and a plurality of light beams 111a in the light source device 100c. The light beams 111a are respectively emitted by the light sources 110a, and the light beams 111a respectively have different wavelength ranges. Moreover, the optical module 120c includes a plurality of reflectors 128. The light beams 111a emitted by the light sources 110a may be different from each other, and the reflectors 128 are respectively disposed on the transmission paths of the light beams 111a. Furthermore, the reflectors 128 respectively have a plurality of reflection surfaces of different inclination angles, in which the optical surfaces 122c are respectively formed by these reflection surfaces. Moreover, the reflection surfaces respectively reflect at least a portion of each of the light beams 111a having at least a predefined wavelength to a plurality of different directions. In the present embodiment, since the reflectors 128 are fixedly configured in the light source device 100c respectively according to the desirable inclination angles of the corresponding reflection surfaces, therefore, the light detector 150 may be omitted in the light source device 100c, the optical module 120c does not need to be electrically connected to the control unit 160, and the operating parameters of the optical module 120c include the arranged positions of the reflectors 128 and the inclination angles of the reflection surfaces. In addition, the control unit 160 can control which light source 110a to emit the light beams 111a according to the use requirement, and thereby decide the wavelength of the light beams 111a outputted from the outlet 180. In other words, the light source device 100c of the present embodiment can emit light beams 111a of different wavelengths by using the light sources 110a, and modulate light of different wavelength spectrums, bandwidths, and illuminance in coordination with the reflection of the fixedly configured optical module 120c, the diffraction from the diffractive optical element 130, the light shielding design of the outlet, and the control of the control unit 160.

FIG. 8 is a schematic view of a light source device according to an embodiment of the disclosure. With reference to FIGS. 4 and 8, a light source device 300 of the present embodiment is similar to the light source device 200 of the previous embodiment, and similar elements are represented by similar reference labels with further elaboration thereof omitted hereafter. However, a difference therebetween lies in that, in the present embodiment, the light source 110 is a broad spectrum light source 110b. Moreover, the light source device 300 further includes a shutter 170, a light detector 150, and a control unit 160. The shutter 170 is disposed on the outlet 180 to block a portion of the light beams 111 (diffraction lights 113) passing through the outlet 180, or allow a portion of the light beam 111 (diffraction lights 113) to pass through the outlet 180. The light detector 150 is disposed beside the outlet 180. Within a part of a time period (e.g. a time period of the scanning mirror swinging back and forth), the light beams 111 emitted by the light source 110b are first diffracted by the diffractive optical element 130 to form the diffraction light 113 (e.g. −1^{st} order diffraction light), the diffraction light 115 (e.g. 0^{th} order diffraction light), and diffraction lights of other orders, and then the optical module 120 reflects the diffraction light of at least one of the orders to the light detector 150.

In the present embodiment, the broad spectrum light source 110b may be a xenon lamp or a deuterium lamp, for example. Moreover, the broad spectrum light source 110b, the optical module 120, the light detector 150, and the shutter 170 are electrically connected with the control unit 160. The control unit 160 can determine a period of the transmission direction of the light beam 111 being changed according to a time for the light detector 150 to detect the light beam 111. In specifics, the control unit 160 can adjust an operating parameter of at least one of the shutter 170 and the optical module 120 according to the determined period of the transmission direction of the light beam 111 being changed. The operating parameter of the shutter 170 includes at least one of a time point and a period of the shutter 170 blocking a portion of the light beams 111 (e.g. diffraction lights 113). The optical module 120 respectively forms the optical surfaces 122 at a plurality of different time points, and the operating parameter of the optical module 120 includes at least one of a time point and a period of forming these optical surfaces 122. In the present embodiment, the light detector 150 is responsive to light of a portion of the wavelength range within the light beam 111, and is irresponsive to light of another portion of the wavelength range within the light beam 111. For example, a filter may be disposed at a light entrance position of the light detector 150. The filter allows light of the aforementioned portion of the wavelength range to pass, and blocks light of the aforementioned another portion of the wavelength range. However, in other embodiments, the light detector 150 may also be responsive to light of all wavelengths within the light beam 111. According to the operating parameters of the optical module 120 and the shutter 170, the control unit 160 can modulate the wavelength of the light beam 111 (diffraction light 113) and determine whether a portion of the light beam (diffraction light 113) can pass through the outlet 180, such that the light source device 300 of the present embodiment can modulate light of different wavelength spectrums, bandwidths, and illuminance. In other words, when the scanning mirror 123 swings, the diffraction lights within the light beam 111 (e.g. the diffraction light 113) having different wavelengths are emitted to the outlet 180 at different time points. By appropriately controlling the open and close times of the shutter 170, the diffraction lights having the desirable wavelengths can pass through the outlet 180, and the diffraction lights having the undesirable wavelengths can be blocked at suitable times by the shutter 170.

In another embodiment, the control unit 160 can control the shutter 170 to open or close according to a response generated by the light detector 150 for light of a portion of the wavelength range within the light beam 111 (e.g. light having a certain wavelength), such that diffraction lights of desirable wavelengths pass through the outlet 180. In specifics, when light of a portion of the wavelength range within the light beam 111 is emitted to the light detector 150 to generate a response from the light detector 150, the control unit 160 can control the shutter 170 to open, so that a portion of the light beams 111 (diffraction lights having the desirable wavelength) can pass through the outlet 180. Moreover, when light having a portion of the wavelength range within the light beam 111 is not emitted to the light detector 150 and no response is generated from the light detector 150, the control unit 160 commands the shutter 170 to close in order to block the outlet 180. In other words, the control unit 160 can also disregard a scan period of the light beam 111, and the control unit 160 determines whether the shutter 170 is opened by whether the light detector 150 detects light having the aforementioned portion of the wavelength range. Alternatively, in other embodiments, the control unit 160 can also determine the open timings of the shutter 170 according to both the scan period of the light beam 111 and whether the light detector 150 detects light having the aforementioned portion of the wavelength range.

In view of the foregoing, the light source device according to embodiments of the disclosure can output light beams outside from the outlet by arranging the light source, the optical module, the diffractive optical element, and the shielding component. Accordingly, the light source device according to the embodiments can control and modulate light of different wavelength spectrums, bandwidths, and illuminance. Moreover, the light outputted by the light source device according to the embodiments can form a continuous spectrum or a spectrum having a single narrow band or multiple narrow bands. Light between the wavelength range of, for example, 400-700 nm and having different illuminance can be emitted in accordance with different needs corresponding to the human body and the therapy. Therefore, preferable applications in the prevention and treatment of human disease can be achieved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A light source device, comprising:
at least one light source emitting at least one light beam, the at least one light beam having a wavelength range;
an optical module disposed on a transmission path of the light beam to provide a plurality of optical surfaces, wherein the optical surfaces respectively have a plurality of different inclination angles, so as to transmit at least a portion of the light beam having at least one predefined wavelength to a plurality of different directions;
a diffractive optical element disposed on the transmission path of the light beam, so as to diffract the light beam; and
a shielding component having an outlet, wherein a portion of the diffracted light beam passes through the outlet to an outside.

2. The light source device of claim 1, wherein the light source is a light emitting diode or a laser diode.

3. The light source device of claim 1, wherein the optical module comprises a scanning minor having a reflection surface, the scanning mirror is configured to swing so as to change an inclination angle of the reflection surface, and the optical surfaces are respectively formed by the reflection surface of the scanning mirror at a plurality of different time points.

4. The light source device of claim 1, wherein the optical module comprises:
a curved rail; and
a reflector sliding on the curved rail, the reflector having a reflection surface, wherein when the reflector moves to a plurality of different positions on the curved rail, an inclination angle of the reflection surface is different, and the optical surfaces are formed by the reflection surface when the reflector respectively slides to these different positions.

5. The light source device of claim 1, wherein the at least one light source is a plurality of light sources, the at least one light beam is a plurality of light beams, the light beams have different wavelength ranges, the optical module has a plurality of reflectors respectively disposed on the transmission paths of the light beams, the reflectors respectively have reflection surfaces of a plurality of different inclination angles, the optical surfaces are respectively formed by the reflection surfaces, and the reflection surfaces respectively reflect at least a portion of each of the light beams having the at least one predefined wavelength to a plurality of different directions.

6. The light source device of claim 1, wherein the diffractive optical element is a transmissive diffractive optical element or a reflective diffractive optical element.

7. The light source device of claim 1, wherein the diffractive optical element is a diffraction grating, a computer generated holograph, or a holographic optic element.

8. The light source device of claim 1, wherein the diffractive optical element has at least one phase structure set, the phase structure set comprises a plurality of phase structures, the phase structures are at least partially different, the optical surfaces cause the light beam to be respectively incident on different phase structures at a plurality of different incident angles, and at least a portion of the phase structures diffracts a portion of a diffraction light of at least a portion of the light beam having at least a predefined wavelength to the outlet.

9. The light source device of claim 8, wherein the at least one phase structure set of the diffractive optical element is a plurality of phase structure sets, the at least one light beam emitted by the light source is a plurality of light beams having different wavelength ranges, the light beams are respectively incident on the phase structure sets of the diffractive optical element, and the phase structure sets respectively diffract portions of the diffraction lights of the portions of the light beams having the predefined wavelengths to the outlet.

10. The light source device of claim 1, further comprising a light detector, wherein the light beam emitted by the light source is transmitted to the light detector within a part of a time period.

11. The light source device of claim 10, further comprising a control unit determining a period of a transmission direction of the light beam being changed according to a time for the light detector to detect the light beam.

12. The light source device of claim 11, wherein the control unit adjusts an operating parameter of at least one of the light source and the optical module according the determined period of the transmission direction of the light beam being changed.

13. The light source device of claim 12, wherein the light source is a pulse light source, and the operating parameter of the light source comprises at least one of a time point and a period of the light source generating a pulse.

14. The light source device of claim 12, wherein the optical module respectively forms the optical surfaces at a plurality of different time points, and the operating parameter of the optical module comprises at least one of a time point and a period of forming the optical surfaces.

15. The light source device of claim 11, wherein the light detector is responsive to light of a portion of the wavelength range within the light beam, and is irresponsive to light of another portion of the wavelength range within the light beam.

16. The light source device of claim 11, wherein the light detector is disposed on a side of the diffractive optical element.

17. The light source device of claim 1, wherein the optical module transmits the light beam from the light source to the diffractive optical element, and the diffractive optical element diffracts a portion of the light beam from the optical module to the outlet.

18. The light source device of claim 1, wherein the diffractive optical element diffracts light beam from the light source to the optical module, and the optical module transmits a portion of the light beam from the diffractive optical element to the outlet.

19. The light source device of claim 18, wherein the light source is a broad spectrum light source, and the light source device further comprises a shutter disposed on the outlet to block the portion of the light beam passing through the outlet, or allow the portion of the light beam to pass through the outlet.

20. The light source device of claim 19, wherein the broad spectrum light source is a xenon lamp or a deuterium lamp.

21. The light source device of claim 19, further comprising a light detector disposed beside the outlet, wherein the light beam emitted by the light source is transmitted to the light detector within a part of a time period.

22. The light source device of claim 21, further comprising a control unit determining a period of a transmission direction of the light beam being changed according to a time for the light detector to detect the light beam.

23. The light source device of claim 22, wherein the control unit adjusts an operating parameter of at least one of the shutter and the optical module according the determined period of the transmission direction of the light beam being changed.

24. The light source device of claim 23, wherein the operating parameter of the shutter comprises at least one of a time point and a period of the shutter blocking the portion of the light beam.

25. The light source device of claim 23, wherein the optical module respectively forms the optical surfaces at a plurality of different time points, and the operating parameter of the optical module comprises at least one of a time point and a period of forming the optical surfaces.

26. The light source device of claim 19, further comprising:
a light detector disposed beside the outlet, wherein the light detector is responsive to light of a portion of the wavelength range within the light beam, and is irresponsive to light of another portion of the wavelength range within the light beam, and
a control unit, wherein when the light detector generates a response due to light of the portion of the wavelength range within the light beam being emitted to the light detector, the control unit controls the shutter to open so that the portion of the light beam passes through the outlet.
